(19) United States
(12) Patent Application Publication
(10) Pub. No.: US 2014/0259816 A1
(43) Pub. Date: Sep. 18, 2014

(54) FINANCIAL TRANSACTION CARD DISPLAYS AND RELATED DESIGNS

(71) Applicant: Nathan D. Ehrlich, Duluth, GA (US)

(72) Inventor: Nathan D. Ehrlich, Duluth, GA (US)

(21) Appl. No.: 13/837,899

(22) Filed: Mar. 15, 2013

(51) Int. Cl. B42D 15/02

(52) U.S. Cl. CPC B42D 15/02
USPC 40/124.01

(57) ABSTRACT

Disclosed is a financial transaction card display comprising a display comprising a first front surface and a first back surface, a financial transaction card coupled to a portion of the first front surface of the display, wherein the financial transaction card includes a second front surface and a second back surface, wherein the second front surface comprises a depiction of a food product, and wherein the second back surface is facing the first front surface of the display; and an elongated object coupled to a portion of the first front surface of the display or to a portion of the second front surface of the financial transaction card such that a first end of the elongated object covers a portion of the depiction of the food product and a second end of the elongated object extends away from the depiction of the food product such that the elongated object appears to be a candle in the depiction of the food product.

### FIELD OF THE INVENTION

This invention relates to financial transaction card display that can include a display or carrier, a financial transaction card, and an elongated object. In certain aspects, the financial transaction card and the display or carrier can have depictions of food products and/or flames, wherein the elongated object can be positioned such that it appears as a candle in the food product.

### SUMMARY OF THE INVENTION

In one aspect, this disclosure provides a financial transaction card display that comprises a display or carrier (display and carrier are used interchangeably throughout the specification and claims), a financial transaction card, and an elongated object (such as an elongated writing instrument).

The display can have a front surface and an opposing back surface. The display can have depictions of various elements on its front or back surface. For instance, a depiction of a work bench with tools (e.g., wrenches, screw drivers, pliers, hammers, etc.) can be included on the front surface. A depiction of a flame can be included on the front surface. Further, the display can have an aperture through its front surface and back surface such that it can be used to hang the display on an elongated rod or other protrusion (e.g., a hook). The display may also have a perforation so that the upper portion having the aperture can be removed.

The financial transaction card can be coupled or removably coupled to a portion of the front surface of the display. An adhesive can be used to removably couple the card to the display. Non-limiting examples of such adhesives include pressure sensitive adhesives, holt-melt adhesives, elastic adhesives (e.g., “fugitive” glue), etc. The financial transaction card can include a front surface and an opposing back surface. In one aspect, the back surface of the financial transaction card can be adjacent to the front surface of the display such that the front surface of the financial transaction card is visible. The front and/or back surfaces of the financial transaction card can have a depiction of a food product. Non-limiting examples of a food product include a cookie, a cake, a piece of cake, a cupcake, a pastry, a drink, etc. In particular instances, the depiction of the food product can be a cupcake. The financial transaction card can also include written words (e.g., “happy birthday”, “happy b-day”, etc.) and/or a banner in which the written words can be placed thereon. In certain instances, the financial transaction card may be preloaded with an amount of money or credit, including $5, $10, $15, $20, $25, $30, $35, $40, $45, $50, $55, $60, $65, $70, $75, $80, $85, $90, $95, $100 or more. In other embodiments, a purchaser may select the amount to load on the card.

The elongated object can be coupled to or removably coupled to a portion of the front surface of the display or to a portion of the front surface of the financial transaction card or to portions of both surfaces. The adhesive discussed above can be used to removably coupled the elongated object to the display and/or financial transaction card surface(s). The coupling can be such that a first end of the elongated object is adjacent to or covers a portion of the depiction of the food product and a second end of the elongated object extends away from the depiction of the food product. This can have the effect of making the elongated object appear to be a candle or appear to have the shape of a candle (e.g., a birthday candle). In one instance, where the display surface has a depiction of a flame, the second end of the elongated object can be adjacent to or can cover a portion of the depiction of the flame to further make the elongated object appear to be a candle or appear to have the shape of a candle. As noted above, the elongated object can be an elongated writing instrument (e.g., a pen, pencil, etc.). In particular instances, it can be a pencil (e.g., a standard number #2 pencil, a carpenter pencil, etc.). The pencil can be sharpened or can be partially sharpened or can be unsharpened. The length of the pencil can vary as desired (e.g., 1, 2, 3, 4, 5, 6, 7, or more inches or from 4 to 7 inches, or from 5 to 7 inches or from about 6 inches). In other instances, the elongated object can be a flash light, flash drive, screwdriver, file, drill bit, ruler, air-pressure gauge, etc. In some embodiments, more than one elongated object (e.g., 2, 3, 4, 5, 6, or more) can be included. This could give the appearance of multiple candles within the food product. Similarly, multiple depictions of flames can be included on the display (e.g., 2, 3, 4, 5, 6, or more). Also, multiple food products can be included on the financial transaction card and/or on the display.

The combination of the display, the financial card product, the elongated object, and the depictions of the food product and flame together create a synergistic effect. In particular, together, these parts create a synergistic effect that is greater than the effect of the parts individually, as the appearance of a birthday cake or cupcake or a birthday celebration appears.

In another embodiment there is disclosed an ornamental design for a financial transaction card as shown and described in FIGS. 4 and 5. Some embodiments of such ornamental designs comprise the outer shape of the depicted food product, and may but need not include other details, such as the wrapper, sprinkles, and inner icing contours. In embodiments in which the sprinkles are depicted and claimed, the sprinkles depicted may, in some embodiments, be those shown in FIG. 4 and, in other embodiments, be those shown in FIG. 5 (as is the case for all of the disclosed ornamental designs). In some more specific embodiments, such ornamental designs also include the banner, and may but need not include indicia on the banner. In some more specific embodiments, such ornamental designs also include indicia on the banner, which indicia can include lettering in outline form or solid form (solid form being shown, for example, in FIGS. 4 and 5).

In a further embodiment, there is disclosed an ornamental design for a display-coupled financial transaction card as shown and described in FIGS. 6 to 11. Some embodiments of such ornamental designs comprise the outer shape of the depicted food product on the card (and may but need not include other details on the card, such as the wrapper, sprinkles, and inner icing contours), along with the outer shape of the elongated object, and the shape of the flame on the display (and may but need include other details on the display, such as one or more tools or a tool bench). In embodiments in which sprinkles are depicted and claimed on the card, the sprinkles depicted may, in some embodiments, be those shown in FIG. 6 and, in other embodiments, be those shown in FIG. 5. In some more specific embodiments, the cards of such ornamental designs also include the banner, and may but need not include indicia on the banner. In some more specific embodiments, the cards of such ornamental designs also include indicia on the banner, which indicia can include lettering in outline form or solid form (solid form being shown, for example, in FIG. 6). In some more specific embodiments, the material coupling the elongated object to the display and/or to the card will be depicted in dashed lines.

The phrase “food product” is defined as any substance that can be consumed. It can be in solid or liquid form. Non-limiting examples of food products include a cookie, a cake, a piece of cake, a cupcake, a pastry, a drink, etc.

The term “coupled” is defined as connected, although not necessarily directly, and not necessarily mechanically.

The terms “a” and “an” are defined as one or more unless this disclosure explicitly requires otherwise.

The term “substantially” is defined as being largely but not necessarily wholly what is specified (and include wholly what is specified) as understood by one of ordinary skill in the art. In any disclosed embodiment, the term “substantially” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a financial transaction card display that “comprises,” “has,” “includes” or “contains” one or more elements possesses those one or more elements, but is not limited to possessing only those one or more elements. Likewise, an element of a financial transaction card display that “comprises,” “has,” “includes” or “contains” one or more features possesses those one or more features, but is not limited to possessing only those one or more features.

Furthermore, a structure that is configured in a certain way is configured in at least that way, but may also be configured in ways that are not listed. Metric units may be derived from the English units provided by applying a conversion and rounding to the nearest millimeter.

The feature or features of one embodiment may be applied to other embodiments, even though not described or illustrated, unless expressly prohibited by this disclosure or the nature of the embodiments.

Any embodiment of any of the disclosed financial transaction card displays can consist of or consist essentially of—rather than comprise/include/contain/have—any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure may not be labeled in every figure in which that structure appears. Identical reference numbers do not necessarily indicate an identical structure. Rather, the same reference number may be used to indicate a similar feature or a feature with similar functionality, as may non-identical reference numbers.

Unless otherwise noted, the figures are drawn to scale, meaning that the sizes of the depicted items are accurate relative to each other for at least the embodiments depicted in the figures.

FIG. 1 is a perspective front view of a display-coupled financial transaction card comprising a display, a financial transaction card, and a writing instrument.

FIG. 2 is a left side view of FIG. 1.

FIG. 3 is a right side view of FIG. 1.

FIG. 4 is a front perspective view of a financial transaction card.

FIG. 5 is a front view of FIG. 4.

FIG. 6 is a front perspective view of a display-coupled financial transaction card.

FIG. 7 is a front view of FIG. 6.

FIG. 8 is a left side view of FIG. 6.

FIG. 9 is a right side view of FIG. 6.

FIG. 10 is a top view of FIG. 6.

FIG. 11 is a bottom view of FIG. 6.

With respect to FIGS. 4 to 11, it is contemplated that such FIGS. could form the basis for design applications. For example, FIGS. 4 to 5 can form the basis of a design application for the financial transaction card depicted therein. As for FIGS. 6 to 11, these FIGS. can form the basis of a design application for the display-coupled financial transaction card. The dashed lines in FIGS. 4, 5, 6, 7, 10, and 11 form no part of any future claimed designs. All other surface(s) or portion(s) of the financial transaction cards and/or displays not shown in FIGS. 4 to 11 or otherwise described in the specification form no part of any future claimed design.

### DETAILED DESCRIPTION

Various features and advantageous details are explained more fully with reference to the non-limiting embodiments that are illustrated in the accompanying drawings and detailed in the following description. It should be understood, however, that the detailed description and the specific examples, while indicating embodiments of the invention, are given by way of illustration only, and not by way of limitation. Various substitutions, modifications, additions, and/or rearrangements will become apparent to those of ordinary skill in the art from this disclosure.

In the following description, numerous specific details are provided to provide a thorough understanding of the disclosed embodiments. One of ordinary skill in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

FIG. 1 depicts an embodiment of a display-coupled financial transaction card assembly (10) comprising a display or carrier (11) having a depiction of a flame (16), an elongated object (12), and a financial transaction card (13) having a depiction of a cupcake (14), which is one example of the displays of the present invention. As explained below, the combination of the display, the financial card product, the elongated object, and the depictions of the cupcake (14) and flame (16) create a synergistic effect that is greater than the effect of the parts individually, as the appearance of a cupcake with a candle appears. In FIG. 1, a financial transaction card (13) having a depiction of a cupcake (14) is removably coupled to the front surface of a display (11) such that the front surface of the financial transaction card (13) and the cupcake depiction (14) can be seen. The display (11) also includes a depiction of a flame (16). The elongated object, which in the depicted embodiment is a writing instrument (12), includes one end that covers a portion of the cupcake depiction (14) and another that is adjacent to or covers a portion of the flame (16), thereby giving the display assembly (1) the appearance of a cupcake with a candle. In some embodiments, more than one elongated object can be used such that it give the appearance of multiple candles within the food product. Further, multiple depictions of flames (16) can be included on the display (11). Also, multiple food products can be included on the financial transaction card (13) and/or on the display. The financial transaction card (13) can also include indicia (e.g., in this instance “happy birthday”, although other variations of “happy birthday” such as “happy b-day” are contemplated). The financial transaction card (13) in this embodiment has a standard size of a credit or debit card (e.g., 3.370×2.125 inches or ID-1 format), although other sizes are contemplated. Further, the writing instrument (12) in this embodiment is a carpenter pencil that has not yet been sharpened. As previously indicated, partially sharpened and sharpened pencils are also contemplated. Further, carpenter pencils, standard pencils, mechanical pencils, etc., are also contemplated. Even further, any elongated object can be used (e.g., flash light, flash drive, screwdriver, file, drill bit, ruler, air-pressure gauge, etc.), as the elongated object can have the appearance of a candle if placed in appropriate position between the cupcake depiction (14) and the flame depiction (16). The display (11) can be made of a wide variety of materials (e.g., plastic, paper, cardboard, laminated cardboard, etc.). The financial transaction card (13) is typically made of a plastic material. Also, the financial transaction card (13) may be loaded or provided with a certain amount of money or credit, or may be configured to be loaded or provided with a certain amount of money or credit. In various embodiments the amount may be in predetermined increments ($25, $50, $100, etc.) or the amount may be specified by a customer.

FIGS. 2 and 3 are left and right side views of the display-coupled financial transaction card assembly (10) of FIG. 1. In this embodiment, the writing instrument (12) is reversibly coupled to at least a portion of the front surface of the display (11) and at least a portion of the front surface of the financial transaction card (13). It is contemplated, however, that the writing instrument (12) can be coupled to the display (11) without coupling to the financial transaction card (13). Alternatively, the writing instrument (12) can be coupled to the financial transaction card (13) without coupling to the display (11). The coupling in this embodiment is through an adhesive (17). The adhesive (17) is a removable elastic adhesive (e.g., “fugitive” glue), which allows the financial transaction card (13) or the writing instrument (12), or the glue itself, to be easily removed without leaving a residue. Other substances, including other satisfactory adhesives, and materials like tape may be used in other embodiments for the same purpose. The adhesive (17) can be applied to a portion of a surface of the writing instrument (12) followed by contacting the adhesive with the display (11) or the financial transaction card (13) or both. A sufficient amount of pressure can be used to ensure that the writing instrument (12) remains attached or adhered to a portion of the surface of the display (11) or card (13) or both.

The above specification and examples provide a complete description of the structure and use of an exemplary embodiment. Although certain embodiments have been described above with a certain degree of particularity, or with reference to one or more individual embodiments, those skilled in the art could make numerous alterations to the disclosed embodiments without departing from the scope of this invention. As such, the illustrative embodiment of the present display-coupled financial transaction card is not intended to be limited to the particular forms disclosed. Rather, they include all modifications and alternatives falling within the scope of the claims, and embodiments other than the one shown may include some or all of the features of the depicted embodiment. For example, components may be combined as a unitary structure and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not to be interpreted as including means-plus- or step-plus-function limitations, unless such a limitation is explicitly recited in a given claim using the phrase(s) “means for” or “step for,” respectively.

1. A financial transaction card display comprising:
a display comprising a first front surface and a first back surface;
a financial transaction card coupled to a portion of the first front surface of the display, wherein the financial transaction card includes a second front surface and a second back surface, wherein the second front surface comprises a depiction of a food product, and wherein the second back surface is facing the first front surface of the display; and
an elongated object coupled to a portion of the first front surface of the display or to a portion of the second front surface of the financial transaction card such that a first end of the elongated object covers a portion of the depiction of the food product and a second end of the elongated object extends away from the depiction of the food product such that the elongated object appears to be a candle in the depiction of the food product.

2. The financial transaction card display of claim 1, wherein the elongated object comprises an elongated writing instrument.

3. The financial transaction card display of claim 2, wherein the first front surface of the display comprises a depiction of a flame, and wherein the second end of the elongated writing instrument is adjacent to or covers a portion of the depiction of the flame.

4. The financial transaction card display of claim 3, wherein the depiction of the flame is a picture, a drawing, an image, an outline, an illustration, or a sketch.

5. The financial transaction card display of claim 4, wherein the depiction of the flame is a picture or image.

6. The financial transaction card display of claim 3, wherein the elongated writing instrument is removably coupled to a portion of the first front surface of the display or to a portion of the second front surface of the financial transaction card.

7. The financial transaction card display of claim 6, wherein the elongated writing instrument is removably coupled to a portion of the first front surface of the display and to a portion of the second front surface of the financial transaction card.

8. The financial transaction card display of claim 6, wherein the elongated writing instrument is removably coupled to a portion of the first front surface of the display or to a portion of the second front surface of the financial transaction card with an adhesive.

9. The financial transaction card display of claim 3, wherein the elongated writing instrument is a pencil.

10. The financial transaction card display of claim 9, wherein the pencil is a carpenter pencil.

11. The financial transaction card display of claim 9, wherein the pencil is sharpened.

12. The financial transaction card display of claim 9, wherein the pencil is from 4 to 7 inches in length.

13. The financial transaction card display of claim 1, wherein the financial transaction card is loaded with an amount of money or credit or loadable with an amount of money or credit.

14. The financial transaction card display of claim 1, wherein the financial transaction card is removably coupled to a portion of the first front surface of the display.

15. The financial transaction card display of claim 14, wherein the financial transaction card is removably coupled to a portion of the first front surface of the display with an adhesive.

16. The financial transaction card display of claim 1, wherein the depiction of the food product is a picture, a drawing, an image, an outline, an illustration, or a sketch.

17. The financial transaction card display of claim 16, wherein the depiction of the food product is a picture or image.

18. The financial transaction card display of claim 1, wherein the food product is a cupcake.

19.-21. (canceled)

22. An ornamental design for a financial transaction card as shown and described in FIGS. 4 to 5.

23. An ornamental design for a display-coupled financial transaction card as shown and described in FIGS. 6 to 11.
